(19) United States
(12) Patent Application Publication
(10) Pub. No.: US 2006/0114929 A1
(43) Pub. Date: Jun. 1, 2006

(54) Contention resolution covering all ports of a data switch

(76) Inventor: Edwin Rijpkema, Nieuwerkerk a/d Ijssel (NL)

Correspondence Address: PHILIPS INTELLECTUAL PROPERTY & STANDARDS, P.O. BOX 3001, BRIARCLIFF MANOR, NY, 10510, US

(21) Appl. No.: 10/538,569

(22) PCT Filed: Nov. 20, 2003
(86) PCT No.: PCT/IB03/05357

§ 371 Date: Jun. 15, 2005

(30) Foreign Application Priority Data
Dec. 19, 2002 (EP) 02080495.1

(51) Int. Cl. H04L 12/43

(52) U.S. Cl. 370/461

(57) ABSTRACT

A communication network has one or more interconnected data switches having I/O ports and at least one virtual port. The communication network further has means for subjecting the ports to one and the same contention resolution process.

The present invention relates to a communication network comprising one or more interconnected data switches having I/O ports and at least one virtual port.

The present invention also relates to a data switch for application in the communication network, and to a contention resolution method.

Such a communication network and contention control method are known from U.S. Pat. No. 6,411,617 B1. The known communication network system comprises a plurality of network nodes, each including a network data packet switch. The data switch has input/output (I/O) ports and virtual ports formed by dedicated input ports and dedicated output ports. Network node congestion control is selectively applied at the dedicated output port of the network switch. The dedicated output ports, which generally show a broader bandwidth than the bandwidth of regular input and output ports, are coupled through virtual paths to external or integrated extender devices for implementing a functionality that accompanies the data switch.

It is an object of the present invention to provide a simplified communication network and contention control method, which alleviates the burden on required associated soft- and hardware.

Thereto the communication network according to the invention is characterized in that the communication network further comprises means for subjecting said ports to one contention resolution process.

It is an advantage of the communication network and method according to the present invention that it is found, despite the fact that virtual ports take a special position relative to input and output (I/O) ports of the data switch, that the problem of contention and in particular contention resolution may be seen as a problem that may include contention resolution on one or more input and/or output ports, and one or more dedicated or virtual ports. With this notion contention at both one or more I/O ports and one or more virtual ports can be resolved combined, as contention at a virtual port of the data switch simply may be treated as contention on some I/O port of the switch. This saves both associated software and hardware, control, as well as precious processing time.

In an embodiment of the communication network according to the invention, the at least one virtual port is a virtual input port or a virtual output port.

This way contention on either the virtual input port or the virtual output port may be treated as contention on some input port or on some output port of the data switch.

In a further embodiment of the communication network according to the invention, the at least one virtual port is an internal virtual port or an external virtual port.

Advantageously no distinction has to made when it comes to the treatment of contention with regard to internal or external virtual ports of the data switch.

In a still further embodiment of the communication network according to the invention, the at least one virtual port is an addressable virtual port.

Advantageously various ways of addressing the virtual port are possible.

In still another embodiment of the communication network according to the invention, the at least one virtual port is coupled to at least one resource. Such a resource may either be an internal or an external resource, whereas such a resource may comprise one or more of the following means: means for testing, means for debugging, means for programming, means for configuring. Such means may be associated with each data switch, and will generally be controlled by a system or network manager.

Further dependent claims outline other merits and advantageous features of preferred embodiments of the invention.

At present the communication network and contention resolution method according to the invention will be elucidated further together with their additional advantages, while reference is being made to the appended drawing, wherein similar components are being referred to by means of the same reference numerals. In the drawing:

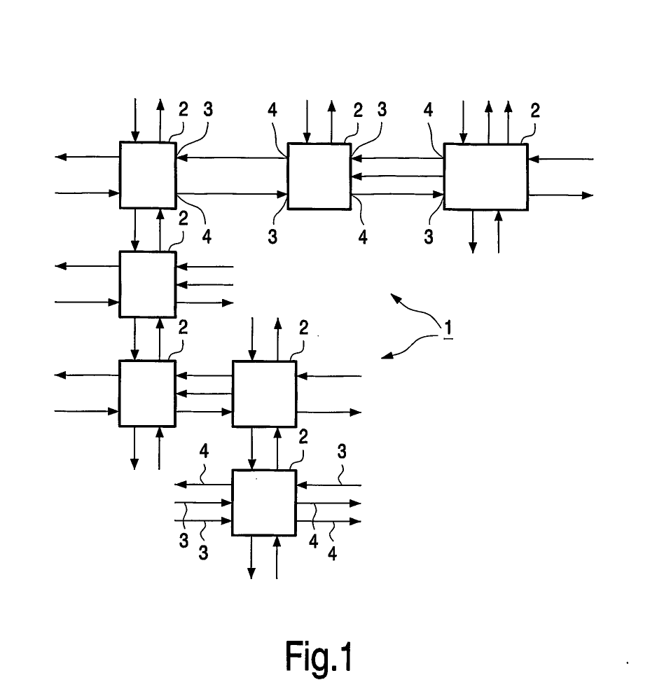

FIG. 1 shows a schematic view of a communication network comprising several data switches;

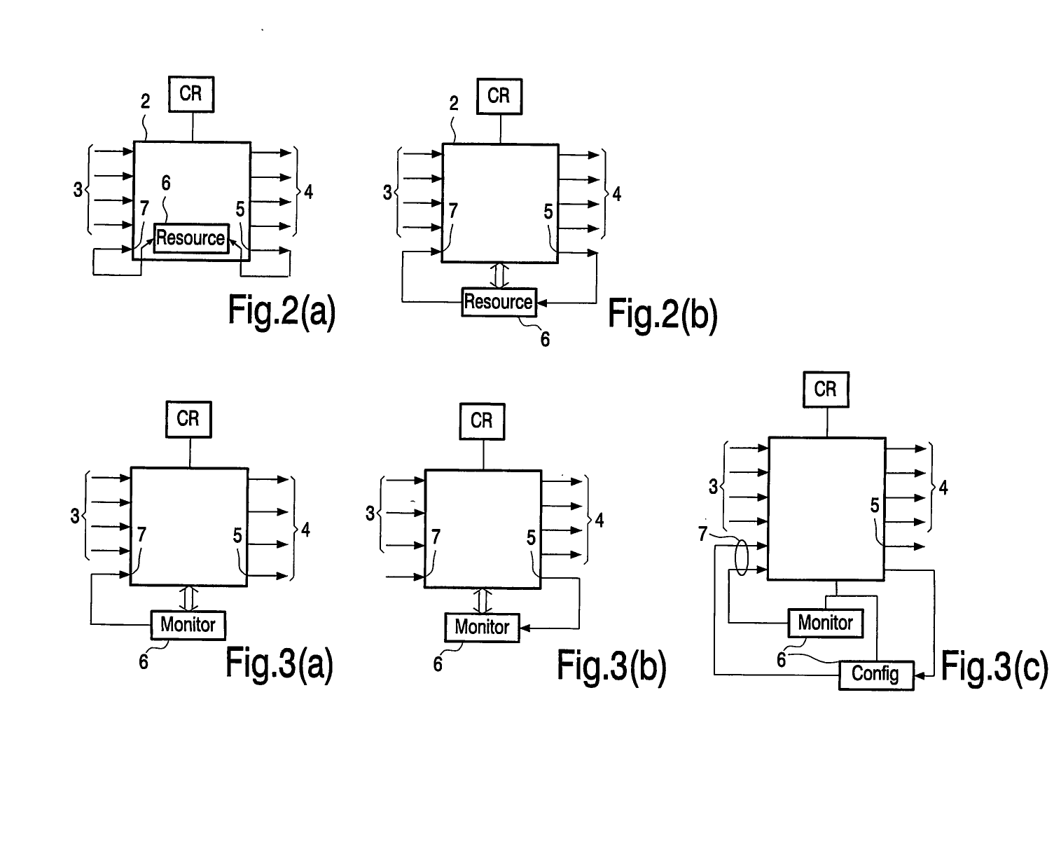

FIGS. 2(a), 2(b) show schematic views of data switches provided with internal and external resources respectively;

FIGS. 3(a), 3(b), and 3(c) show possible ways of implementing virtual input ports and virtual output ports on the data switches of FIGS. 2(a), and 2(b); and

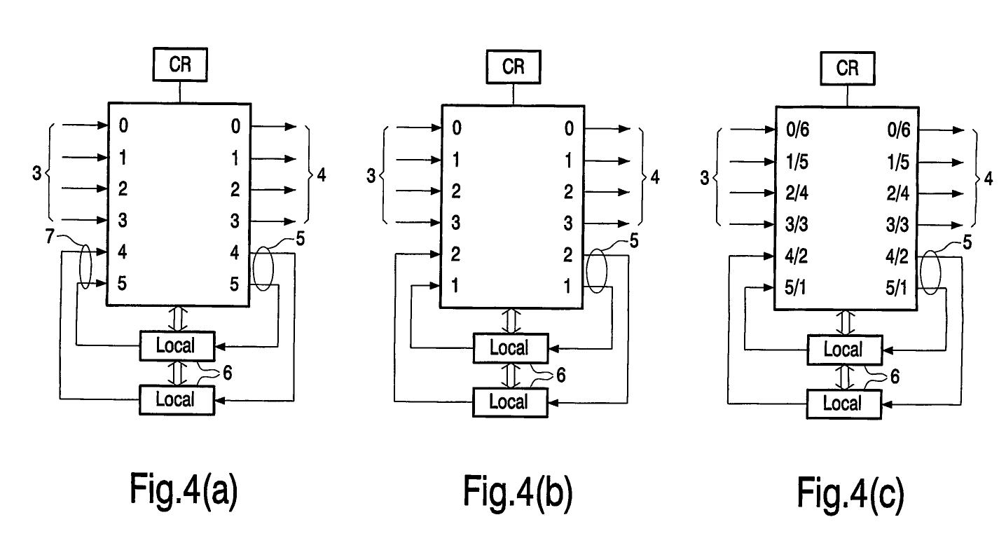

FIG. 4(a), 4(b) and 4(c) show possible ways of addressing virtual ports on the data switches for application in the communication network of FIG. 1.

In present day systems-on-chip and network-on-chip architectures there is the challenge of managing the complexity of designing chips containing billions of semiconductor components. Wires and busses are no longer suitable for dealing with the dynamic communication required in those architectures. Communication services of various types provide data communication in a communication network 1 as shown in FIG. 1. The communication network 1 comprises interconnected data switches 2, also known as notes, routers, matrix switches or the like. The data switches comprise input ports 3, and output ports 4. Control means CR are coupled to each of the switches 2 for connecting selected inputs 3 to selected outputs 4 in order to secure reliable data communication throughout the network 1 and to other networks (not shown), such as for example the Internet.

In practice such a data switch 2 is also capable of performing functions, like for example testing, debugging, programming or configuring, in order to function as required in the network. Functional data necessary for implementing these functions in one or more of the data switches 2 is associated with routing information that can either be attached to the data to be communicated, like in a header such as with packet switching, or may be sent to the switch 2, like in time division switched schemes. The functional data which is meant for a particular switch 2 or for a group of switches 2 is routed to the particular switch 2 and provided at one or more of the input ports 3 of the switch 2.

The switch 2, as shown in FIGS. 2(a) and 2(b) has internal and/or external virtual ports 5, which are coupled to either internal or external resources 6 in the data switch 2, which resources 6 form the various means that are capable of performing the associated above mentioned data switch functions, based on the functional data.

The input ports 3 if properly controlled couple the functional data an the input port 3 concerned to the relevant addressed virtual output port or virtual output ports 5 in order to provide data input to the resources 6. In fact one could say that a regular port of a data switch becomes a virtual port if that port is coupled to a resource, which resource performs functions that are associated to the data switch 2. However the fact that the virtual port is excluded from regular data transfer through the switch 2 also excluded it from regular contention resolution processes.

Various implementations of ports of the data switch 2 are shown in FIGS. 3(a), 3(b) and 3(c). The various resources 6 perform the required functions. Conversely the resources 6 may want to send data to a virtual input port 7, which data may be sent through appropriate output ports 4 to one or more other data switches 2 in the network 1. For example FIG. 3(a) shows a case where a monitor as resource 6 only provides data to a virtual input port 7 of the switch 2, and FIG. 3(b) shows a case where the monitor only receives data from virtual output port 5. The number of input ports 3, 7 does not have to be equal to the number of output ports 4, 5.

Under normal circumstances a method is being applied for avoiding contention, either on input ports 3 or on output ports 4 of the data switch 2. Such a method is implemented in contention resolution means CR schematically shown in FIGS. 2, 3, 4, (a), (b), (c), as the case may be. Input contention arises if an input port 3 wants to address more than two output ports 4, and output contention arises if an output port 4 is addressed by two or more input ports 3. A proper scheduling of connections between input and output ports leads to a resolution of such contentions. If for example the well known matrix scheduling algorithm with or without a slot table or any other suitable contention resolution algorithm is used by the contention resolution means CR for handling contention on input ports or output ports 3 or 4 that very same algorithm can now be used to resolve contention on the virtual input ports 7 and/or virtual output ports 5. So now contention on a local, either internal or external resource 6 may be treated by the means CR in a similar way as contention on any other input 3 or output port 4 of the data switch. No dedicated contention algorithm is required for solving contention problems on virtual ports 5, 7.

Normally any matrix data scheduling algorithm requires the addressing of ports. FIGS. 4(a), 4(b) and 4(c) show possible ways of also addressing the virtual ports 5, 7 of the data switch 2 in order to easily apply the contention resolution method. The usual way of addressing the I/O ports 3, 4 is to number them. This numbering may now be extended to the virtual ports so that all the ports 3, 4, 5, and 7 are subjected to one contention resolution process. Several options are shown in the figures. FIG. 4(a) shows that the numbering of the ports 3, 4 is extended to the dedicated or virtual ports 5, 7. Such a possible method is very simple. FIG. 4(b) shows that the numbering of the virtual ports 5, 7 starts all over again, which has the advantage that a special routing mode could be introduced which exploits the fact that fewer amounts of bits are required for addressing the I/O ports 3, 4 and the virtual ports 5, 7 respectively. The embodiment of FIG. 4(c) shows a combination of the aforementioned two methods, but at the expense of requiring more bits for addressing.

1. A communication network comprising one or more interconnected data switches having I/O ports and at least one virtual port, characterized in that the communication network further comprises means for subjecting said ports to one contention resolution process.

2. The communication network according to claim 1, wherein the at least one virtual port is a virtual input port or a virtual output port.

3. The communication network according to claim 1, wherein the at least one virtual port is an internal virtual port or an external virtual port.

4. The communication network according to claim 1, wherein the at least one virtual port is an addressable virtual port.

5. The communication network according to claim 1, wherein the at least one virtual port is coupled to at least one resource.

6. The communication network according to claim 5, wherein the at least one resource is an internal or external resource.

7. The communication network according to claim 6, wherein the at least one resource comprises one or more of the following means: means for testing, means for debugging, means for programming, means for configuring.

8. The communication network according to claim 7, wherein the at least one resource are means for one of the associated data switches.

9. A data switch for application in the communication network according to claim 1, the communication network comprising one or more interconnected data switches having I/O ports and at least one virtual port, characterized in that the communication network further comprises means for subjecting all said ports to one contention resolution process.

10. A contention resolution method, characterized in that the method involves contention resolution covering ports of at least one data switch having I/O ports and at least one virtual port.
